(19) United States
(12) Patent Application Publication
(10) Pub. No.: US 2018/0199403 A1
(43) Pub. Date: Jul. 12, 2018

(54) METHODS, APPARATUSES, AND SYSTEMS FOR OPERATING LIGHT EMITTING DIODES AT LOW TEMPERATURE

(71) Applicant: Digital Lumens, Inc., Boston, MA (US)

(72) Inventors: Scott D Johnston, Boston, MA (US); Christopher Elledge, Arlington, MA (US); Hugh Medal, Everett, MA (US); Frederick M. Morgan, Canton, MA (US); John F. Egan, Middleton, MA (US)

(73) Assignee: Digital Lumens, Inc., Boston, MA (US)

(21) Appl. No.: 15/916,234

(22) Filed: Mar. 8, 2018

Related U.S. Application Data
(62) Division of application No. 14/927,413, filed on Oct. 29, 2015, now Pat. No. 9,924,576.
Application No. 14/927,413 is a continuation of application No. PCT/US2014/035990, filed on Apr. 30, 2014.
(60) Provisional application No. 61/817,671, filed on Apr. 30, 2013.

(51) Int. Cl. H05B 33/08

(52) U.S. Cl. CPC H05B 33/089; H05B 33/0851; H05B 33/083; H05B 33/0812; H05B 33/0827; H05B 33/0845

(57) ABSTRACT

Light-emitting diodes (LEDs) generate light more efficiently than high-intensity discharge lamps or high-intensity fluorescent lamps. Driving a series of LEDs with a constant-voltage primary supply and a low-voltage LED driver keeps efficiency high. Unfortunately, LED forward voltage varies as a function of temperature: at low temperature, the forward voltage rises. Placing the LEDs in series magnifies the forward voltage increases. This makes it difficult to drive a series of LEDs at low temperature with a constant-voltage supply because the forward voltage can exceed the power supply voltage. To account for this behavior, an exemplary LED lighting fixture includes a “bypass” circuit that, when engaged, effectively removes at least one LED from each series string of LEDs to bring the total forward voltage below the power supply voltage. The low-voltage driver circuit monitors temperature, and engages the “bypass” circuit when necessary to ensure that DC voltage is not exceeded.

### CROSS-REFERENCE TO RELATED APPLICATIONS

This application claims priority to PCT Application No. PCT/US2014/035990; filed on Apr. 30, 2014, entitled “Methods, Apparatuses, and Systems for Operating Light Emitting Diodes at Low Temperature”, which is hereby incorporated herein by reference in its entirety. PCT Application No. PCT/US2014/035990 in turn claims a priority benefit of U.S. Application No. 61/817,671, filed Apr. 30, 2013, and entitled “Methods and Systems for Operating LEDs at Low Temperature,” which application is hereby incorporated herein by reference in its entirety.

### BACKGROUND

Compared to traditional lighting systems such as high intensity discharge (HID), high intensity fluorescent (HIF), and high pressure sodium (HPS) lightings that are used in a variety of settings, including large scale facilities such as warehouses, light emitting diodes (LEDs) provide superior performance. Some of the advantages include low energy consumption (with excellent lighting levels), fast switching, long lifetime, etc.

### SUMMARY

Embodiments of the present invention include a lighting fixture that includes a plurality of light emitting diodes (LEDs) arranged in series, a constant-voltage power supply operably coupled to the LEDs, a sensor in electrical communication with the LEDs, and a bypass circuit operably coupled to the sensor. In operation, the power supply provides a constant voltage across the LEDs. The sensor measures a decrease in the LEDs' temperature; this decrease in temperature causes an increase in series voltage across the LEDs. And the bypass circuit short-circuits at least one LED in response to the increase in the series voltage so as to reduce the series voltage below the constant voltage provided by the constant-voltage power supply.

In some examples, the bypass circuit enables the short-circuited LED for a predetermined period. While the LED is re-enabled, the sensor measures a change in the LEDs' temperature, e.g., for a period of 20 ms or less. If the temperature change indicates that the series voltage remains high, the bypass circuit short-circuits the LED again. Otherwise, the bypass circuit leaves the LED enabled until the temperature drops again. The bypass circuit can also short-circuit at least one LED if the series voltage exceeds a threshold voltage.

Another embodiment comprises an apparatus for illuminating an environment at cold temperature. An exemplary apparatus includes at least one LED, a linear driver circuit operably coupled to the LED, a sensor in electrical and/or thermal communication with the at least one light emitting diode, a processor operably coupled to the to the sensor, and a switch (e.g., one or more transistors) operably coupled to the processor and to the linear driver circuit. In operation, the linear driver circuit provides a drive current to the LED. The sensor detects a variation in the drive current from a predetermined drive current caused by a decrease in temperature of the LED, e.g., based on the LED's temperature. The processor generates a drive current control signal, such a pulse-width modulated digital signal, based on at least in part on the variation measured by the sensor. And the switch controls the drive current provided to the LED by the linear drive circuit in response to the drive current control signal from the processor. The processor may also dim the LED by varying the drive current control signal.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows a plot of the dependence of forward voltage on temperature for an exemplary light emitting diode.

FIG. 1B shows the current versus voltage diagram of an LED.

FIG. 2A shows an exemplary LED-based lighting fixture operating in a cold-storage facility.

FIG. 2B shows an exemplary lighting system in the freezer section of a supermarket.

FIG. 3A shows an exemplary bypass circuit regulating, in response to a drop in temperature as measured by a sensor, the voltage available to a plurality of LEDs by short-circuiting one of the LEDs in the plurality of LEDs.

FIG. 3B shows an exemplary lighting fixture that includes several LED light bars connected to a direct current (DC) power supply through respective low-voltage drivers and a bypass circuit.

FIG. 4 shows an exemplary bypass circuit regulating the voltage available to a plurality of LEDs in response to an increase in series voltage due to a drop in temperature by short-circuiting an LED in the plurality of LEDs.

FIG. 5 shows an exemplary bypass circuit regulating, in response to a drop in temperature as measured by a sensor, the voltage available to a plurality of LEDs by short-circuiting any number of LEDs in the plurality of LEDs.

FIG. 6 shows an exemplary bypass circuit regulating the amount of voltage available to a plurality of LEDs in response to an increase in series voltage due to a drop in temperature by short-circuiting any number of LEDs in the plurality of LEDs.

FIG. 7 shows an exemplary bypass circuit regulating, in response to a drop in temperature, the amount of drive current available to a plurality of LEDs by switching a transistor using a drive current control signal.

FIG. 8 shows a flow diagram of an exemplary process for managing the voltage across LEDs operating in a low temperature environment.

FIG. 9 shows a flow diagram of an exemplary process for managing the current supplied to a plurality of LEDs operating in a low temperature environment.

FIG. 10 is a circuit diagram that shows an exemplary bypass circuit.

FIG. 11 is a circuit diagram that shows an exemplary temperature sensor.

### DETAILED DESCRIPTION

For the cold storage industry, facility lighting has been a significant challenge owing to the subpar performance in refrigerated environments of the main industrial lighting choices, high intensity discharge (HID) and high intensity fluorescent (HIF) lighting fixtures. In general, these lighting systems consume too much energy, generate too much heat, and are expensive to maintain. And low-temperature environments, such as those in cold-storage facilities, exacerbate the disadvantages of HID and HIF lighting.

In contrast, an exemplary smart light-emitting diode (LED) lighting fixture offers consistent performance and durability in all temperature environments. For example, an LED lighting system can frequently cycle on/off without impacting the longevity of the lamp source or fixture, instantly return to full intensity when activated, even in −40° F. chillers, and generate minimal heat during operations, significantly reducing refrigeration loads.

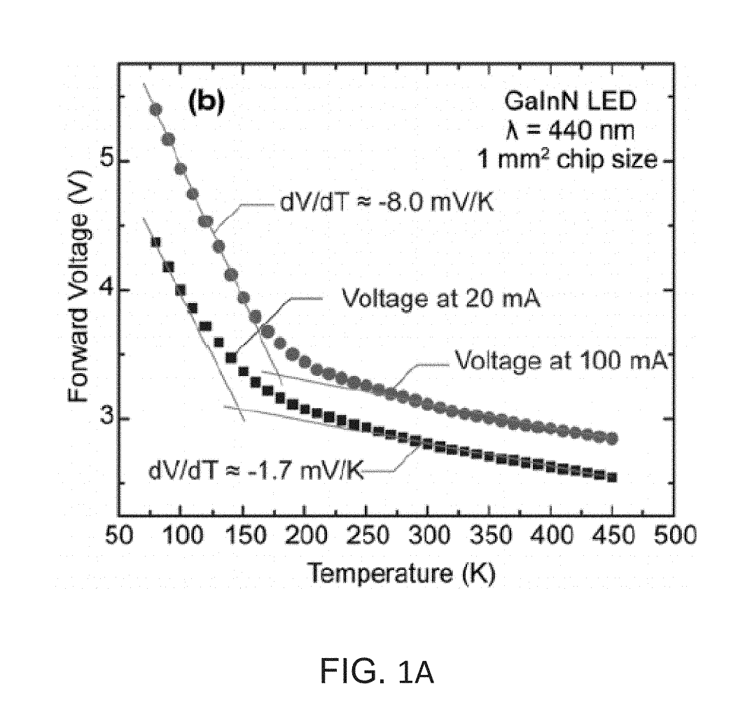

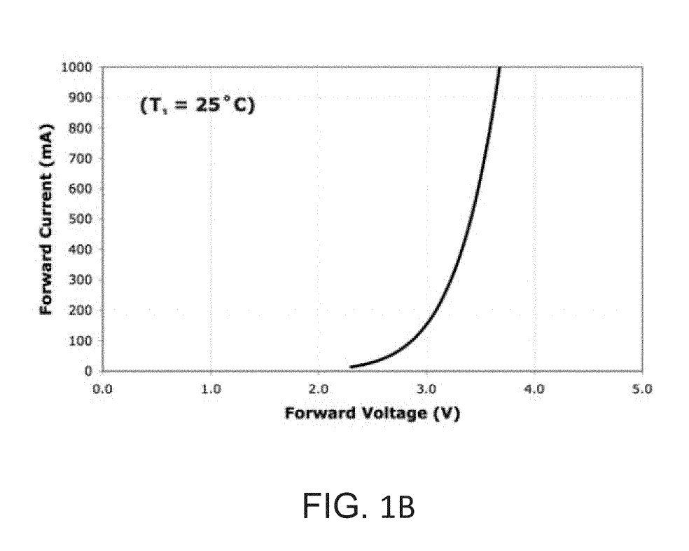

However, an LED's forward voltage has a significant variation with temperature. For example, as shown in FIG. 1A for the specific example of a GaInN LEDs the forward LED voltage to maintain constant current increases with falling ambient temperatures. Over a temperature range of about 273 K to about 300 K, the forward voltage for a single LED increases by about 0.1 V. For strings of LEDs arranged in series, the total fluctuation in forward voltage can reach several volts, depending on the number of LEDs in series, their temperature performance, and the total temperature drop. Unfortunately, for LED drivers supplied by constant voltage sources, which tend to be more efficient and less expensive than other power supplies, it may not be possible to increase the voltage to compensate for increases in LED forward voltage at low temperature. In other words, a linear LED driver supplied by an efficient constant-voltage power supply might not provide enough voltage to drive LEDs arranged in series at extremely cold temperatures, such as typical cold-storage facility temperatures that run from −40° F. (−40° C.) to −4° F. (−20° C.).

LED drive current also varies with forward voltage as shown in FIG. 1B, which is a plot of forward current versus forward voltage (an I-V curve) for an LED at temperature of 25° C. For an LED to emit an appreciable amount of light, the forward voltage should exceed a characteristic on-voltage value, which typically is in the range of about 2-3 volts at room temperature as shown in FIG. 1B. Changing the LED temperature causes the current-voltage relationship to vary, in effect increasing or decreasing the LED voltage according to the relationship depicted in FIGS. 1A and 1B. But because an LED's voltage, current, and temperature are interrelated, knowledge of any two of these quantities makes it possible to solve for the third quantity. For example, if the current is fixed (can be assumed to be fixed), a temperature measurement can be used to find the voltage, or vice versa.

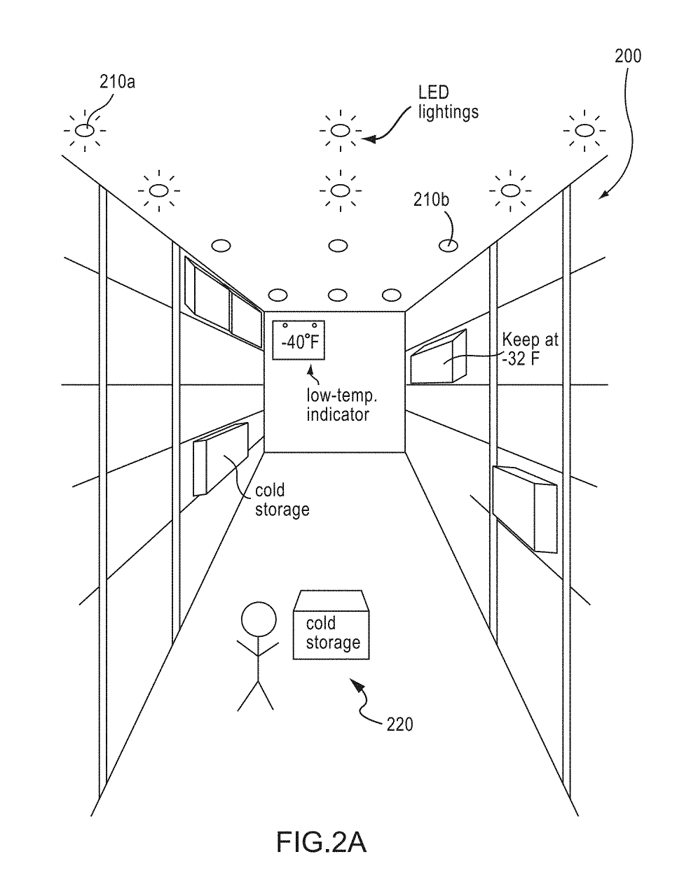

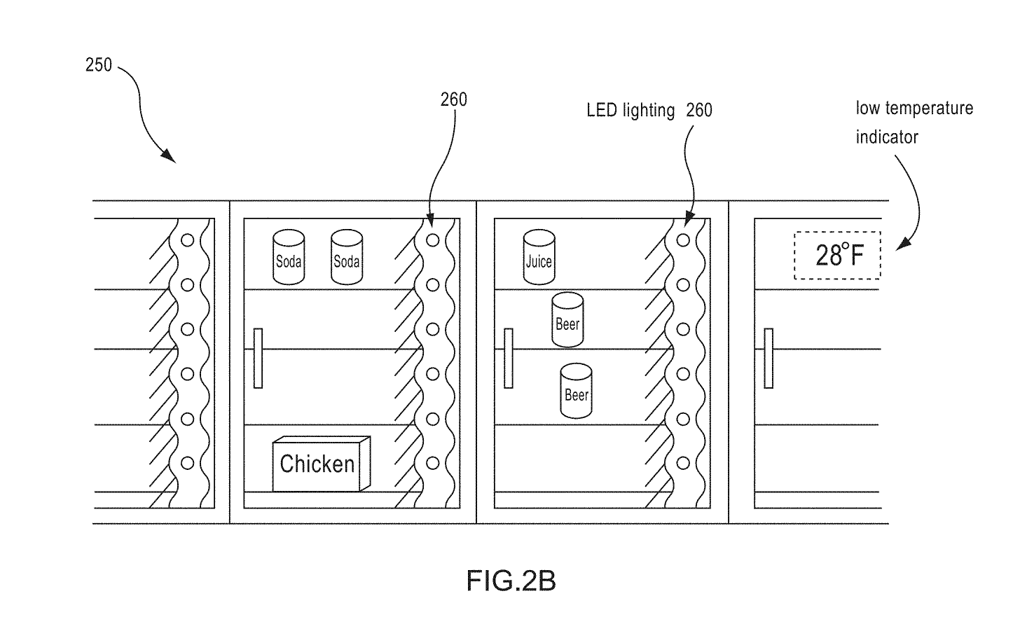

FIG. 2A shows LED-based lighting fixtures 210a and 210b (collectively, lighting fixtures 210) that uses the relationship among LED current, voltage, and temperature to operate in cold environments (e.g., environments at temperatures of 0° C., −5° C., −10° C., −15° C., −20° C., −25° C., −30° C., −35° C., −40° C., etc.). For instance, the fixture such as a refrigerated storage warehouse 200, with constant-voltage power supplies (not shown). Smaller fixtures 260 can be used in smaller cold environments, such as the refrigerators 250 shown in FIG. 2B.

As explained in greater detail below, each fixture 210 includes a sensor that measures (decreases in) temperature. Each fixture 210 also includes a processor or other circuitry that predicts the corresponding (increase in) LED forward voltage using the LEDs' temperature-voltage relationship at a given current. To compensate for changes in LED forward voltage, the lighting fixtures 210 and 260 include bypass circuits that short circuit one or more of the LEDs in the lighting fixture 210 to reduce the overall forward voltage of the plurality of LEDs. Further, since LEDs are more efficient at producing light at low temperatures (e.g., below 0° C.), so short-circuiting one or more LEDs may not significantly reduce the fixture's light output. In some cases, the bypass circuit may short-circuit the LED(s) to reduce power consumption for a given light output level at a given temperature.

In other cases, the LED fixtures may regulate the current supplied by the driver circuit(s) to the LEDs. For instance, an exemplary LED fixture may include a microcontroller or other processor that determines fluctuations in the LED drive current, possibly by measuring temperature or the current itself. The microcontroller may modulate the drive current by applying a drive current control signal (e.g., a pulse-width modulated signal) to the gate of a bipolar transistor that conducts current from the power supply to the driver or from the driver to the LEDs.

In addition, the LED-based lighting fixtures 210 can deliver light where and when needed, unlike HID and HIF fixtures, in part because of LEDs' fast response times. For instance, the LED fixture 210 may include a processor that increases light output when there is activity 220 in the area 200 and dims the lights when the area 200 is unoccupied as indicated by a signal from an ambient light sensor (not shown). The processor 200 may also brighten or dim the lights in response to a signal from an ambient light sensor to save energy in a process known as “daylight harvesting.” For more information on occupancy- and daylight-based LED control, see, e.g., the following patent documents, each of which is incorporated herein by reference in its respective entirety: U.S. Pat. No. 8,536,802; U.S. Pre-Grant Publication No. 2012/0143357 A1; U.S. Pre-Grant Publication No. 2012/0235579 A1; U.S. Pre-Grant Publication No. 2014/0028199 A1; and International Patent Application No. WO 2013/067389.

Bypass Circuits to Reduce LED Forward Voltage

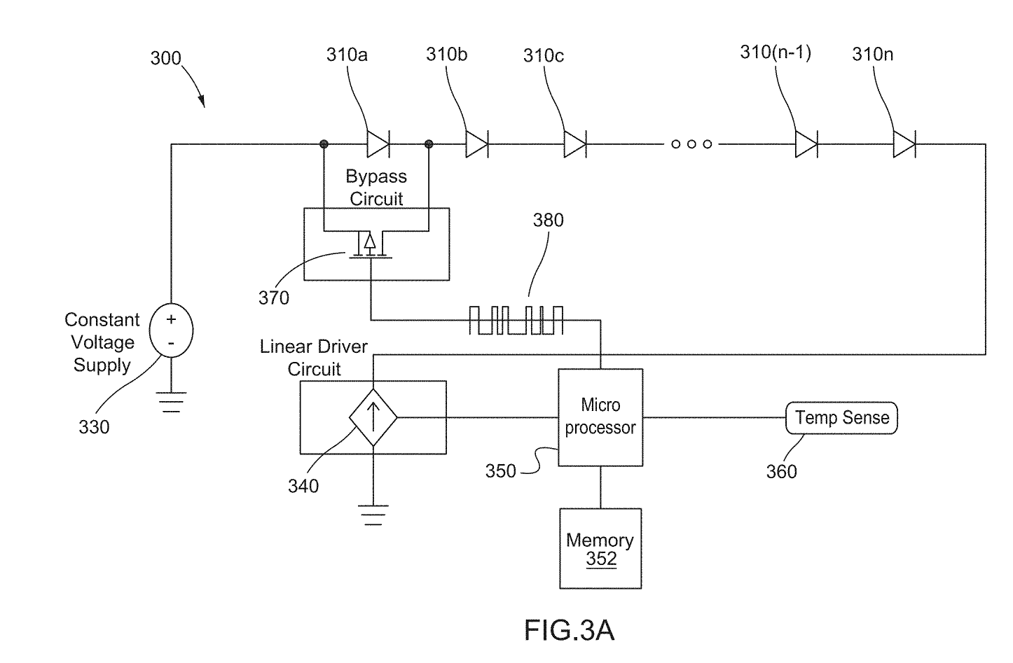

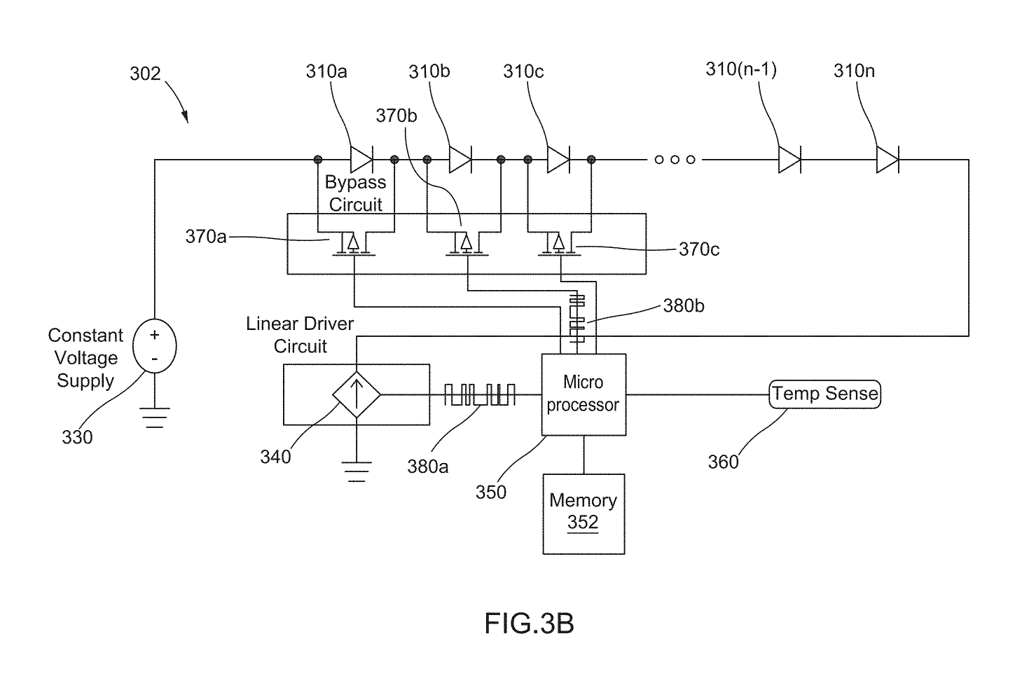

FIG. 3A shows a lighting fixture 300 that includes a plurality of LEDs 310a-310n (collectively, LEDs 310) that are in series with each other. For instance, the fixture 300 may include 10, 11, 12, 13, 14, 15, or more LEDs 310 in series depending on the available voltage, which is supplied by a constant-voltage power supply 330 via a non-switching linear driver 340. If the power supply 330 provides 60 V or less (e.g., 42 V with a tolerance of ±0.5 V), it may be considered by Underwriters' Labs to be a Class 2 power Unit and thus subject to slightly less rigorous design constraints than certain other power supplies.

The linear driver 340 may be optimized for a given temperature (e.g., room-temperature), but fluctuations in ambient temperature may reduce the efficiency of the driver 340 and the LEDs 310. The lighting fixture 300 also includes one or more sensors 360 capable of measuring temperature, voltage overhead, and/or LED current drive may sense the voltage provided for driving the LEDs 310. And the fixture 300 includes a microcontroller 350 or other processor, that determines, based on the sensor measurements, whether there is sufficient voltage to drive the LEDs 310. A bypass circuit 370, shown in FIG. 3A as a switch, that short-circuits the first LED 310a if the voltage is too low to drive all of the LEDs 310.

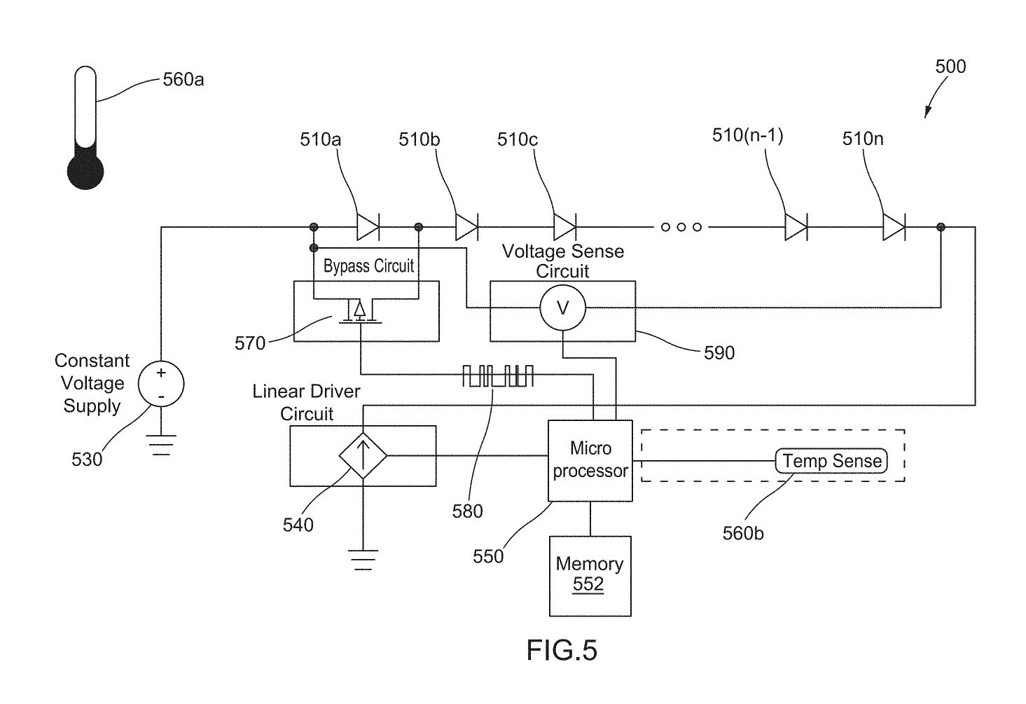

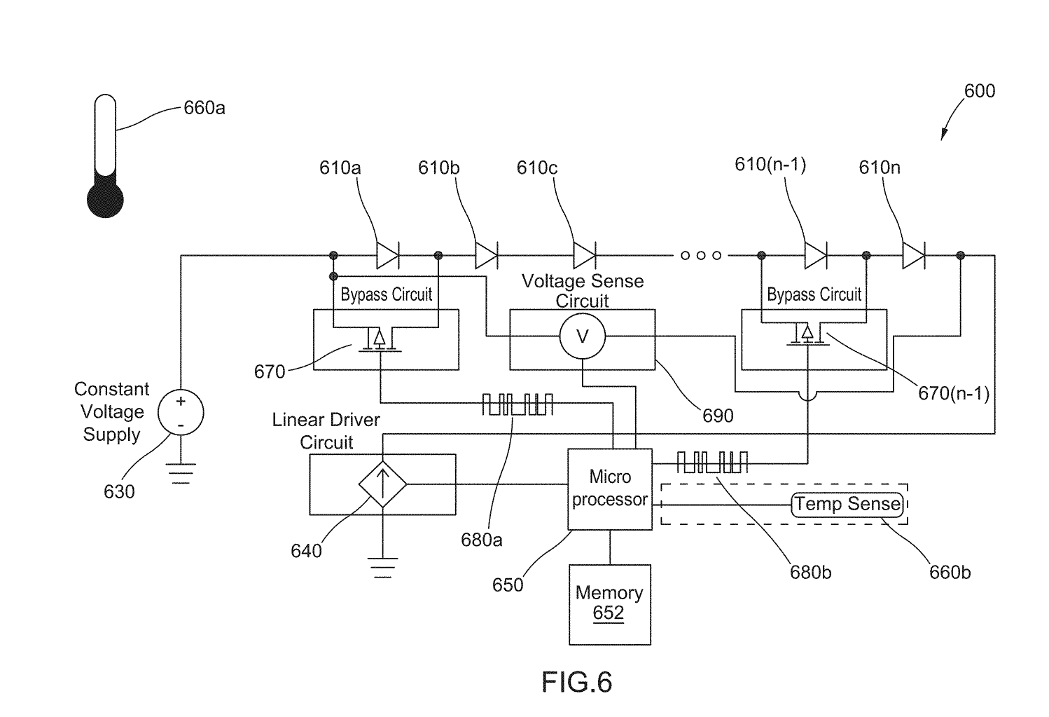

For example, the sensor 360 may be implemented as a fully-integrated digital temperature sensor like the one shown in FIG. 11 and described below. The sensor 360 can also be implemented using other components, including but not limited to thermistors, thermocouples, and so forth. In operation, the sensor 360 measures a decrease in temperature and predict an associated voltage increase by using a relationship, such as a look-up table stored in memory (not shown), that relates voltage with temperature. As an alternative embodiment, the sensor 360 may measure a decrease in temperature and transmit a signal representing the measurement to a microcontroller 350 that uses the relationship relating LED forward voltage with temperature to determine the change in LED forward voltage at the lower temperature. For Cree LEDs, the conversion is about −2.5 mV/° C.; for other LEDs, the conversion may be higher or lower. In this case, the microcontroller 350 looks up the voltage-temperature conversion in a memory 352, which stores these characteristics in a look-up table or other representation of the LEDs' temperature-dependent current-voltage (I-V) characteristics. (In other embodiments, a voltmeter may be used to measure the voltage across the series, as discussed in more detail with respect to FIGS. 5 and 6.)

If the sensor 360 and/or processor 350 determine that there is not sufficient voltage and/or there is a requirement that the forward voltage should not exceed a prescribed amount (e.g., to protect the integrity of the LEDs), the first LED 310a (or, equivalently, the last LED 310n) may be “bypassed” (e.g., short-circuited) to reduce the overall forward voltage of the LEDs 310. Bypassing one or more of the LEDs reduces the total forward voltage and makes it possible to drive at least some of the LEDs 310 at full current.

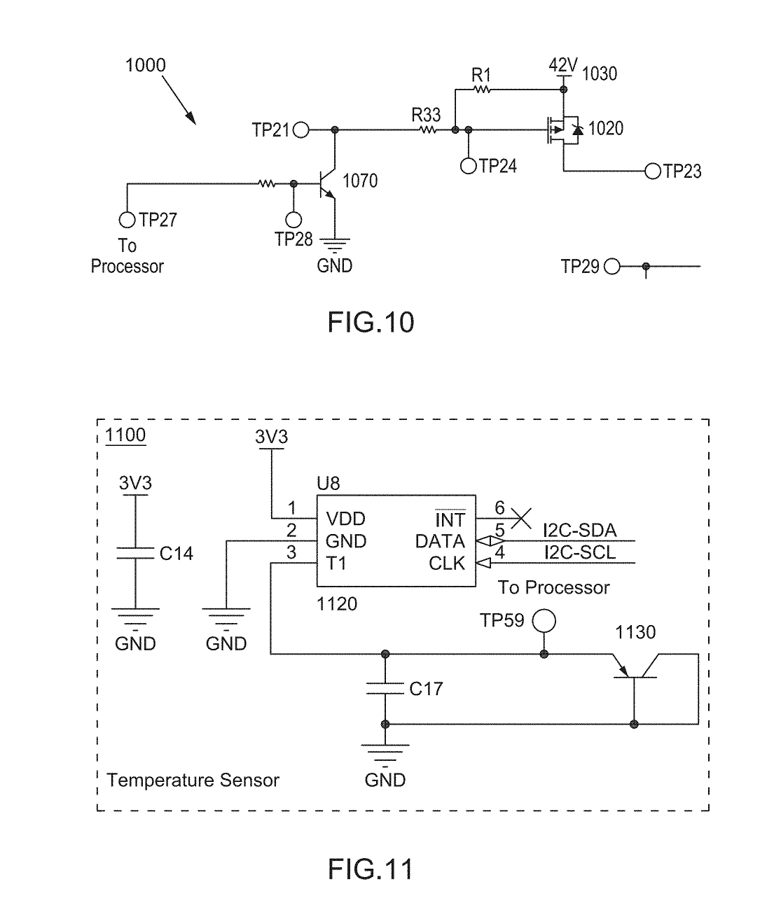

In some implementations, the microcontroller 350 may apply a “bypass-circuit” control signal (e.g., a pulse-width-modulated (PWM) digital signal) 380 to a bypass circuit 370 to effect the bypassing of the first LED 310a (or the last LED 310n) in the series 310. This bypass circuit 370 may include a field-effect transistor or switching component in addition to various support components, e.g., as described below with respect to FIG. 10. It can be implemented separately from the linear driver circuit 340 or located on the same circuit board as the linear driver circuit 340. Upon receiving the control signal 380, the bypass-circuit 370 short-circuits the first LED 310a and consequently reduce the overall forward voltage needed for the plurality of LEDs. (In alternative implementations, the bypass circuit 370 may be included in the linear driver 340, and the processor 350 may transmit the control signal directly to the linear driver 340.)

Once the first LED 310a has been electrically removed (short-circuited) from the series of LEDs 310, it may be checked periodically to determine if there is sufficient voltage available to drive all the LEDs 310. For example, if the temperature has increased, the power supply DC voltage may be adequate to provide a lower forward voltage to drive the LEDs 310. In such embodiments, the microcontroller 350 and bypass-circuit 370 may periodically enable the first LED 310a to check whether normal, un-bypassed operation has become possible. This periodic disabling of the bypass circuit may be performed at a rate too fast to observe with the naked eye, e.g., at a speed of 100 Hz or faster (i.e., a period less than about 20 milliseconds). The fast switching speed leads to an imperceptible flicker of the first LED 310a and possibly of the other LEDs 310 as well. If the measurement shows that the forward voltage has dropped below the supply voltage (e.g., because the temperature has risen), then the bypass circuit may re-enable the first LED 310. Otherwise, the bypass circuit may disable the first LED 310a after the measurement and check the voltage again later (e.g., every 30 seconds, 60 seconds, five minutes, ten minutes, etc.).

FIG. 3B shows how multiple “bypass circuits” 370a-370c (collectively, bypass circuits 370) may be coupled to the LEDs 310 to allow for individual “bypassing” of some or all of the LEDs. For example, the bypass circuits 370 may comprise respective transistors, e.g., as shown in FIG. 10. Upon receiving a signal 380b from the microcontroller 350, some or all of these transistors may short out a respective LED 310. For example, in FIG. 3B, bypass circuit 370b is associated with LED 310b, bypass circuit 370c is associated with LED 310c, etc., and each bypass circuit 370 is connected to the microcontroller 350. As such, the microcontroller 350 can switch on or disable the bypass circuits 370 individually and consequently can control the overall total voltage across the LEDs 310 more finely. This may allow the LEDs 310 to illuminate the environment over a wider range of voltage swings (and a wider range of temperatures).

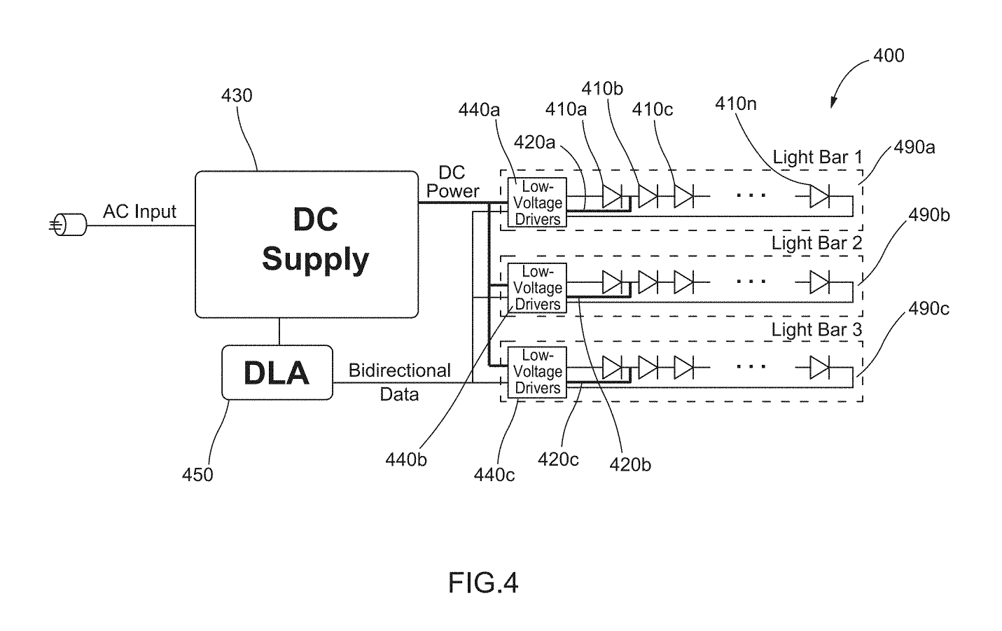

With reference to FIG. 4, a lighting fixture 400 may include light bars 490a-490c (collectively, light bars 490) that each comprise several LEDs 410a-410n (collectively, LEDs 410) in series. Each light bar 490 may be connected to a constant-voltage power supply 430 through a respective low-voltage driver 440a-440c (collectively, drivers 440). In some embodiments, the constant-voltage power supply 430 and low-voltage drivers 440 may be commonly available modular power supplies and drivers, respectively.

As explained above, the combined forward voltages of the LEDs 410 in each light bar 490 may exceed the available DC voltage as the ambient temperature drops. In some implementations, the low voltage drivers 440 of some or all of the light bars 410 may serve as sensors that measure the temperature and/or voltage to determine if the forward voltage exceeds the DC voltage available for each light bar 490. For example, if the same amount of forward voltage should be available to each light bar 490 in the lighting fixture 400, the voltage drivers 440 may check to determine if the total forward voltage at each light bar 490 exceeds the total available DC voltage divided by the number of light bars 490 in the lighting fixture 400.

In some embodiments, the lighting fixture 400 includes a digital light agent (DLA) module 450, which may be implemented as a processor, that may determine, upon receiving the sensing measurements from the voltage drivers 440, if the total forward voltages for the light bars 490 have exceeded the apportioned DC voltages. In other embodiments, the voltage drivers 490 may have made such determinations and may transmit the result to the DLA module 450. Once it has been determined that the forward voltages at one or more of the light bars exceed the available DC voltage, and/or the total combined forward voltage of all the LEDs 410 exceeds the power supply DC voltage, the DLA module 450 may signal the voltage drivers to engage bypass circuits 420a-420c (collectively, bypass circuits 420) included in each light bar 490. In some embodiments, when engaged, the bypass circuits 420 may short-circuit at least one LED 410 in each light bar 490 (FIG. 4 as shown depicts the short-circuiting of the first LED of the light bar). For example, the number of LEDs short-circuited by different bypass circuits may be the same and/or different.

Voltage Monitoring for Low-Temperature Operation

FIG. 5 shows a plurality of LEDs 510a-510n (collectively, LEDs 510) in series with each other and connected to a DC voltage power supply 530 via a non-switching linear driver 540. The linear driver may be optimized for operation at a given temperature (e.g., room-temperature), but fluctuations in ambient temperature may render the operation of the driver and the LEDs less efficient than the optimal case. In embodiments similar to those discussed with reference to FIG. 3A, a sensor 560b measures the ambient temperature 560a and determines whether there is sufficient voltage to drive the plurality of LEDs. In alternative embodiments, the sensor may relay the measurements to the microcontroller 550 which may then look up, in a memory 552, a relationship that relates LED forward voltages with temperature to determine whether there is sufficient voltage to drive the plurality of LEDs.

In other embodiments, a voltmeter 590 measures the voltage overhead across the plurality of the LEDs and may determine if the forward voltage of the plurality of LEDs exceeds the available DC voltage, and provide the microcontroller with the result. In some embodiments, the sensor 590 may measure the forward voltage of the plurality of LEDs and relay the measured data to the microcontroller 550 for the microcontroller to determine if the DC power supply provides sufficient voltage to drive the LEDs 510. Upon determining that the forward voltage has exceeded the power supply DC voltage and/or another prescribed voltage threshold, the microcontroller 550 applies a “bypass-circuit” control signal 580 (e.g., a pulse-width-modulated (PWM) digital signal) to the bypass circuit 570. This causes the bypass circuit 570 to short-circuit the first LED 510a (or last LED, as an alternative example) in the series as shown in FIG. 5. As explained above, short-circuiting the first LED 510a reduces the overall forward voltage needed for the series of LEDs.

After the first LED 510a has been short-circuited and the total forward voltage of the remaining plurality of LEDs reduced to or below the DC voltage from the power supply 530, the microcontroller 550 may disable the bypass switch 570 and bring the shorted LED 510a back online periodically to check if there is enough forward voltage to drive all the LEDs 510. For example, the ambient temperature may have increased and the required total forward voltage for the plurality of LEDs including the shorted-out LED may have been reduced to below the DC voltage. In such embodiments, the microcontroller 550 may periodically disable the “bypass circuit” (e.g., switch off the bypass circuit 570) to check whether un-bypassed operation has become possible by, for example, measuring the total forward voltage again with the voltmeter 590. This periodic disabling of the bypass circuit may be performed at a rate too fast to observe with the naked eye, e.g., at a speed of 100 Hz or faster (i.e., a period less than about 20 milliseconds). For example, the bypass circuit may be disabled for a period less than about 20 milliseconds, 10 milliseconds, 5 milliseconds, etc.

FIG. 6 shows a fixture 600 that includes multiple bypass circuits 620a and 620b (collectively, bypass circuits 620), each of which is coupled to a different LED 610 in the series of LEDs 610a-610n (collectively, LEDs 610). The LEDs 610 are driven by a linear driver circuit 640 that receives power from a constant-voltage power supply 630. As in FIG. 5, a processor 650 determines the temperature by measuring the forward LED voltage with a voltage sense circuit 690 (e.g., a voltmeter) and looking up the temperature 660a corresponding to the measured voltage and drive current in a look-up table or other representation stored in a memory 652. (The processor 600 may also measure the temperature 660a using a temperature sensor 660b and determine the LED forward voltage based on the temperature 660a.) If the processor 650 determines that the forward LED voltage has risen above the power supply voltage or another threshold, the processor generates one or more control signals 680a and 680b for actuating the bypass circuits 670a through 670(n−1) (collectively, bypass circuits 670), only some of which are shown for clarity.

Upon receiving the control signals 680a and 680b from the microcontroller 650, the bypass circuits 670a and 670b may short-circuit the associated LED(s). For example, in FIG. 6, bypass circuit/switch 670a is associated with LED 610a, bypass circuit/switch 670b is associated with LED 610b, etc. As such, the microcontroller 650 can switch on or disable the bypass circuits 670 individually and consequently can control the overall total voltage across the LEDs 610 more finely. This may allow the LEDs 610 to illuminate the environment over a wider range of voltage swings (and a wider range of temperatures). This, for example, may also allow for the wear that ensues from the switching on/off of LEDs to be distributed evenly amongst some or all the LEDs in the series.

If desired, the processor 650 may actuate the bypass circuits 620a and 620b independently. That is, in FIG. 6, the processor 650 can switch on or disable the bypass circuits 620a and 620b individually, and consequently would be able to control the voltage across each LED 610a, 610c separately. This, for example, may allow for the wear that ensues from the switching on/off of LEDs to be distributed evenly amongst some or all the LEDs in the series.

Current Monitoring for Low-Temperature Operation

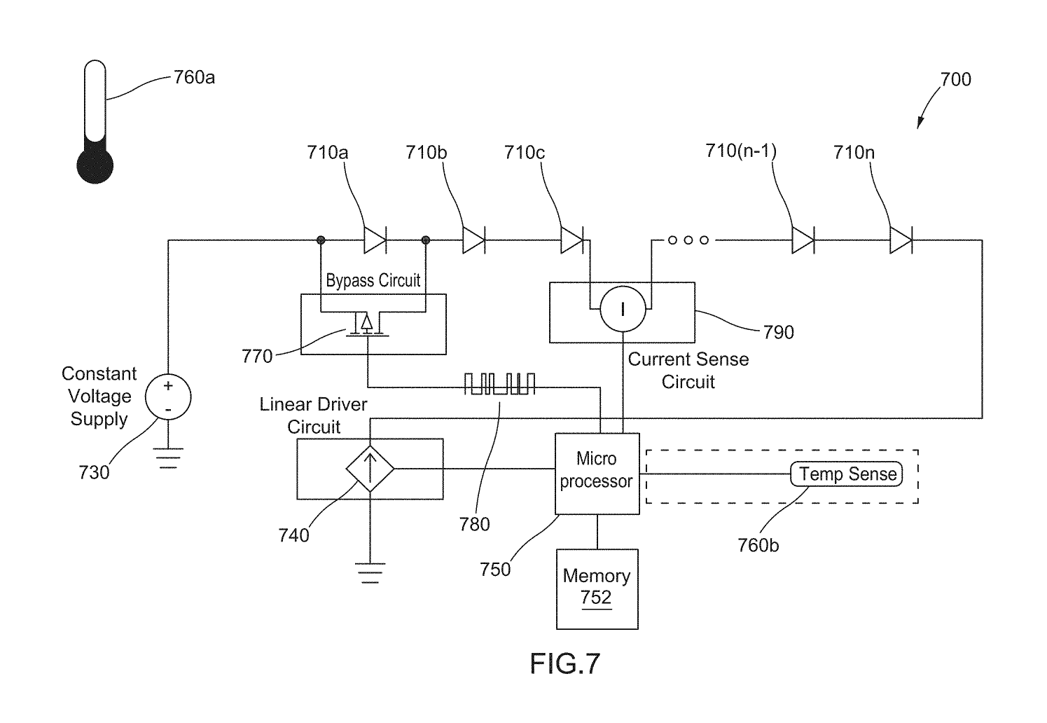

FIG. 7 illustrates an LED lighting fixture 700 with a processor 750 that controls the current supplied to LEDs 710 in response to changes in temperature. The LEDs 710 are connected to a power supply (not shown) via a linear driver 740 and a bypass circuit 770, which may also be part of the linear driver 740. In this case, the linear driver 740 can be an inexpensive device, e.g., a driver that does not provide or use a precision current reference for controlling the current supplied to the LEDs 710. And the bypass circuit 770 can be a transistor-based device like the bypass circuits shown in FIGS. 3A, 3B, 5, 6, 7, and 10. It can also comprise one or more bipolar transistors whose base-emitter voltage drop may be used to set a desired drive current for the LEDs 710. In operation, the processor 750 and the transistors manage the level of the drive current supplied to the LEDs 710.

As shown in FIG. 7, a current sensor 790 coupled in series with the LEDs 710 may measure the LED drive current. The current sensor 790 provides this measurement to the processor 750, which determines whether the drive current has deviated from a desired set-point based on values stored in a memory 752. The processor 750 may also determine the voltage or temperature based on the current measurement.

In other embodiments, a temperature sensor 760b may provide a measurement of the temperature 760a to the processor 750, which determines if the drive current has deviated from the desired drive current set-point based on the temperature measurement based on values stored in the memory 752. For example, the sensor and/or the microcontroller may use a relationship that relates current with temperature, and based on a temperature measurement from the sensor 760b may be able to determine the drive current at the plurality of LEDs 710.

Upon determining the deviation of the drive current from the drive current set-point, in some embodiments, the processor 750 may apply a drive current control signal (e.g., a pulse-width-modulated (PWM) digital signal) 780 to the bypass circuit 770 to adjust the drive current to the desired value. For example, if the ambient temperature drops and the output current exceeds the desired value, the processor 750 may apply a PWM signal to the transistor 770 in order to reduce the driver current to the set-point level. In some embodiments, the same PWM signal can also be used to dim the LEDs 710, e.g., in response to an occupancy event or a change in the ambient light level.

Compensation for Temperature-Induced LED Drive Voltage Fluctuation

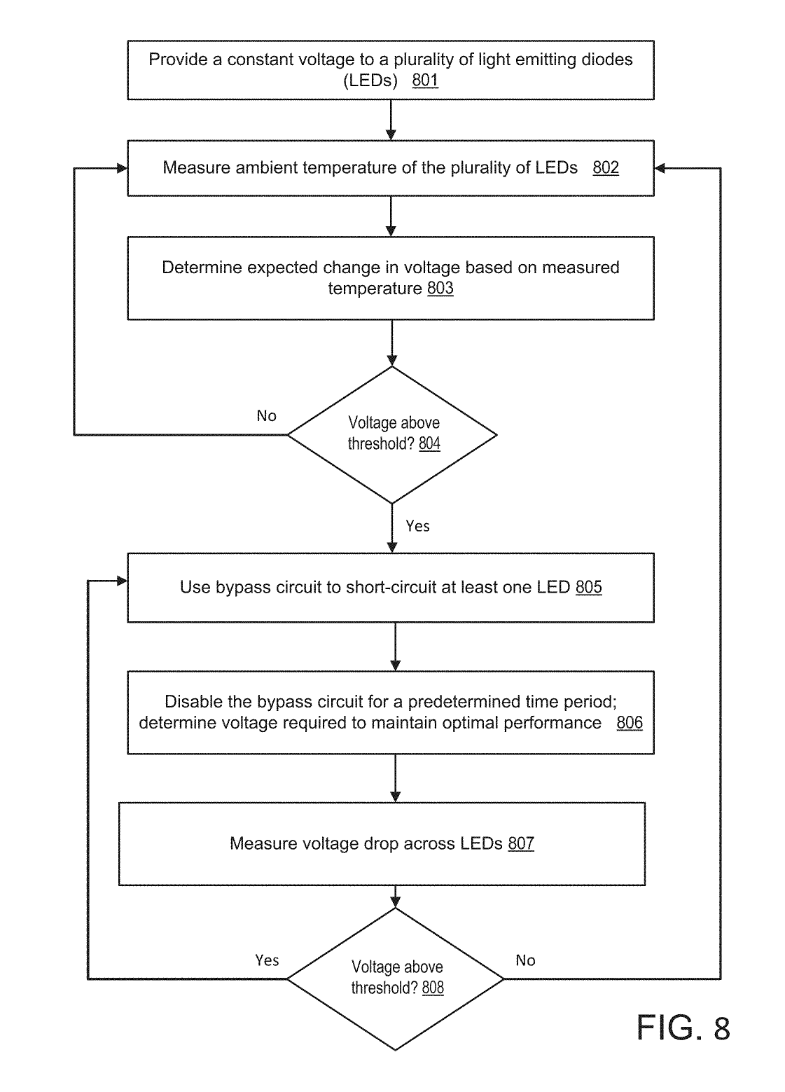

FIG. 8 shows an exemplary process for managing the voltage across LEDs operating in a low temperature environment. In some embodiments, at step 801, a plurality of LEDs are connected to a constant voltage source. For example, the voltage source may be a DC voltage source power supply connected to a linear driver. At step 802, one may measure physical quantities such as ambient temperature of the plurality of the LEDs, and determine, at step 803, the forward voltage of the LEDs by using a relationship that relates temperature to forward voltages. In other embodiments, one may measure the voltage overhead and/or LED current drive and determine the forward voltage.

At step 804, the measured drive voltage is compared to a threshold amount (e.g., the DC voltage provided by the voltage source). If the measured drive voltage is under the threshold, the temperature may be periodically monitored to check if the forward voltage remains under the threshold. If the measured forward voltage exceeds the threshold, at step 805, a processor (e.g., a microcontroller) may effectuate the bypassing of at least one of the LEDs in the plurality of LEDs using a bypass circuit. In some embodiments, the bypassing/short-circuiting may electrically isolate the LED and bring the overall forward voltage across the plurality of LEDs under the threshold.

At step 806, the microcontroller may disable the bypass circuit to determine if the LED forward voltage has dropped. For example, the temperature may have increased and the forward voltage required to drive the LEDs at the desired drive current may have decreased below the threshold. In some embodiments, the switching on/off of the bypass circuit may be undertaken at an imperceptible rate to humans. If a measurement of the forward voltage at step 807 shows that the forward voltage still exceeds the threshold, the bypass circuit is re-engaged and at least one LED is short-circuited at step 808. If, on the other hand, the forward voltage has fallen under the threshold, the bypass circuit is left disabled and the ambient temperature is monitored to check the forward voltage remains below the threshold.

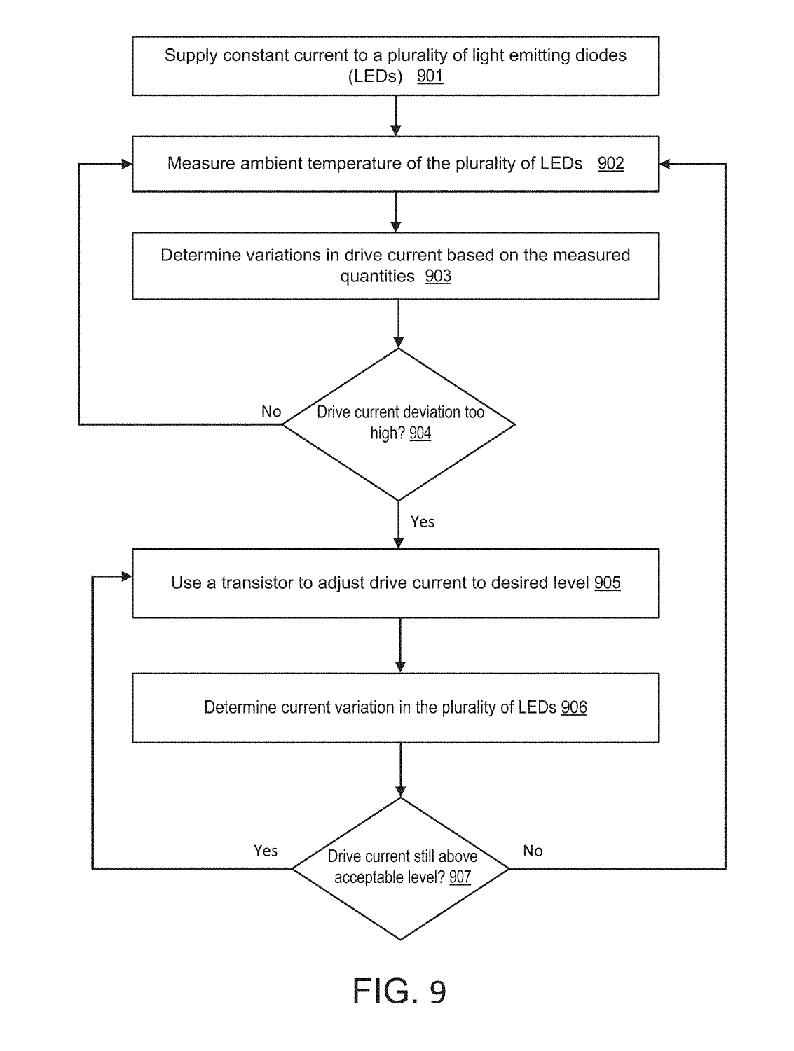

FIG. 9 shows an exemplary process for managing the drive current supplied to a plurality of LEDs operating in a low temperature environment. At step 901, a constant voltage supply is connected to a plurality of LEDs via a linear driver to maintain a given drive current through the plurality of LEDs. At step 902, physical quantities such as ambient temperature of the plurality of the LEDs are measured, and based on the measurements, at step 903, the drive current at the LEDs, and the variations due to fluctuations in temperature may be determined. For example, a drop in temperature may result in an increase in the drive current, and such a change in the drive current may be determined at step 903. In some embodiments, the fluctuations in drive current may also be determined by measuring the current itself and/or voltage overhead using a sensor.

At step 904, if the drive current is determined to be acceptable (e.g., the drive current variations are within some acceptable bounds of the desired drive current set-point), the temperature may be periodically monitored to check if the drive current variations remains within the bounds. If, on the other hand, the current variations are not acceptable, a microcontroller may apply, at step 905, a drive current control signal to a transistor and/or a linear driver circuit to keep the current at the desired level of drive current. For example, if a drop in temperature has resulted in an increase of the drive current, the microprocessor may signal the transistor and/or the linear driver to reduce the drive current to the desired level. At step 906, one may determine if the drive current has attained the desired level, and if so, at step 907, the temperature may be periodically monitored to check the drive current maintains at the desired level. If, on the other hand, the drive current has not reached the desired level, the microcontroller may apply additional signal to the transistor and/or linear driver to adjust the drive current at the plurality of LEDs to the desired level.

Bypass Circuits

FIG. 10 shows a circuit diagram of an exemplary bypass circuit 1000. The bypass circuit 1000 includes a metal-oxide-semiconductor field-effect transistor (MOSFET) 1020 that is connected to a DC voltage power supply 1030. For example, the voltage supply 1030 may be a constant-voltage source (e.g., 42V). The MOSFET 1020 is also connected to a bipolar junction transistor 1070 whose base is connected to a microcontroller or other processor (not shown). In some embodiments, the bypass circuit 1000 also contains several resistors, which may be connected to the transistors in series and/or parallel for use in, amongst other things, monitoring and/or testing the bypass circuit 1000. For example, the MOSFET 1020 may be connected to a resistor R1 in parallel, and the transistor 1070 may be connected to a smaller resistor R37 in series. In some embodiments, a much higher resistor R33 may be placed between the gate of the MOSFET 1020 and the collector of the transistor 1070. In some embodiments, the monitoring and/or testing may be conduct at several points throughout the circuit. For example, in the embodiments depicted in FIG. 10, several test points (TPs), such as TP23, TP24, TP21, TP28 and/or TP27 are used to determine voltage and/or current in the bypass circuit.

Temperature Sensors

FIG. 11 shows a circuit diagram of an exemplary temperature sensor. In some embodiments, the temperature sensor 1100 comprises a thermal sensor 1120 capable of measuring its own internal temperature and the temperature of a remote/external component such as a transistor, diode, LED, etc. In this case, the thermal sensor 1120 comprises a digital temperature supervisor; in other examples, the thermal sensor 1120 may comprise a thermocouple, thermistor, or other suitable temperature-sensitive device or component. In some embodiments, the thermal sensor 1120 may measure the temperature using a transistor 1170. Such a thermal sensor may have an effective capacitance C14. The measurements of the temperature sensor 1100 may be communicated to a microcontroller 1150 via a suitable electrical connection as depicted in FIG. 11.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of designing and making the coupling structures and diffractive optical elements disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes (e.g., of designing and making the coupling structures and diffractive optical elements disclosed above) outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus for illuminating an environment at cold temperature, the apparatus comprising:
at least one light emitting diode;
a linear driver circuit, operably coupled to the at least one light emitting diode, to provide a drive current to the at least one light emitting diode;
a sensor, in electrical and/or thermal communication with the at least one light emitting diode, to sense a variation in the drive current from a predetermined drive current caused by a decrease in temperature of the at least one light emitting diode;
a processor, operably coupled to the to the sensor, to generate a drive current control signal based on at least in part on the variation measured by the sensor; and
a switch, operably coupled to the processor and to the linear driver circuit, to control the drive current provided to the at least one light emitting diode by the linear drive circuit in response to the drive current control signal from the processor.

2. The apparatus of claim 1, wherein the sensor is configured to sense the variation in the drive current based on a temperature of the at least one light emitting diode.

3. The apparatus of claim 1 wherein the drive current control signal comprises a pulse-width modulated digital signal.

4. The apparatus of claim 1, wherein the processor is configured to dim the at least one light emitting diode by varying the drive current control signal.

5. The apparatus of claim 1, wherein the switch comprises a transistor.

6. A method for illuminating an environment at cold temperature, comprising:
(A) providing a drive current to at least one light emitting diode with a linear driver circuit;
(B) sensing a variation in the drive current provided in (A) from a predetermined drive current caused by a decrease in temperature of the at least one light emitting diode;
(C) generating, with a processor, a drive current control signal based on at least in part on the variation measured in (B); and
(D) controlling the drive current provided to the at least one light emitting diode by the linear drive circuit in response to the drive current control signal generated in (C).

7. The method of claim 6, wherein (B) comprises:
sensing the variation in the drive current based on a temperature of the at least one light emitting diode.

8. The method of claim 6, wherein (C) comprises:
generating a pulse-width modulated digital signal representative of a desired change in the drive current.

9. The method of claim 6, wherein (D) comprises:
actuating a transistor in electrical communication with the linear driver circuit.

10. The method of claim 6, further comprising:
dimming the at least one light emitting diode by the processor by varying the drive current control signal.
